(19) United States
(12) Patent Application Publication
(10) Pub. No.: US 2009/0150824 A1
(43) Pub. Date: Jun. 11, 2009

(54) MULTIWINDOW SYSTEM, SECURITY PROTECTION METHOD, AND SECURITY PROTECTION PROGRAM FOR MULTIWINDOW SYSTEM

(76) Inventor: Sanehiro Furuichi, Tokyo (JP)

Correspondence Address: IBM CORPORATION, T.J. WATSON RESEARCH CENTER, P.O. BOX 218, YORKTOWN HEIGHTS, NY, 10598, US

(21) Appl. No.: 12/331,762

(22) Filed: Dec. 10, 2008

(30) Foreign Application Priority Data
Dec. 11, 2007 (JP) 2007-320232

(51) Int. Cl. G06F 3/048; G06F 21/00

(52) U.S. Cl. 715/803; 726/27

(57) ABSTRACT

Security levels and positional information in the Z-axis direction (Z-order) of windows on the screen with a limitation. A program that is assigned a low security level cannot become higher than a program that is assigned a high security level in the Z-axis direction. In addition, a restriction is imposed on information flow via a clipboard and a window message from a higher program to a lower program in the Z-axis direction. The security levels are managed on the window basis according to attributes of files to be accessed or documents to be displayed. The display state of each window in the desktop is dynamically controlled depending on the security level of the window on which a user actually performs operation. The visual states of system resources such as printers and drives are controlled in accordance with the assigned security level.

### CROSS-REFERENCE TO RELATED APPLICATIONS

This application claims priority under 35 U.S.C. §119 from Japanese Patent Application No. 2007-320232 filed Dec. 11, 2007, the entire contents of which are incorporated herein by reference.

### BACKGROUND OF THE INVENTION

1. Field of the Invention

The present invention generally relates to a multiwindow system and method of security management for computers. More specifically, the present invention relates to a graphic user interface technique for protecting information outputted on a screen connected to a computer supporting multiple security levels.

2. Description of Related Art

In a system supporting multilevel security, information flow among entities of different security levels needs to be strictly controlled. In a general multilevel security system, each of the processes is labeled, and access to a file or a device is controlled according to the label. Now, while dedicated operating systems (OS) supporting multilevel security are used in fields such as the military, simplified multilevel security is implemented on a general commercial OS such as Windows® having a structure for mandatory access control mechanism added after installation.

As a method for executing programs having different security levels on a single desktop, Norman Feske and Christian Helmuth, “Overlay Window Management: User interaction with multiple security domains.” Technical Report TUD-FI04-02, March 2004, Technical University Dresden, Germany, discloses a method of displaying transparently integrated multiple window systems under the control of a dedicated window manager. The window manager integrates and outputs images, assigns events of input devices, and blocks the flow of information among different window systems. Although this method allows execution of multiple operations having different security levels on a single desktop, information flow among systems having different security levels is uniformly blocked, so that the operations are excessively restricted. For this reason, usability of the system is diminished, as with the method using the virtualization technique.

Japanese Patent Application Publication No. Hei 5-53748 relates to multiwindow management, and discloses a multiwindow management apparatus that can provide security for each of the windows by separately forbidding input and output to and from each window. In this apparatus, a window input/output controller provides security by controlling the input and output to and from each window with reference to a corresponding security attribute in a security attribute table.

Japanese Patent Application Publication No. Hei 6-149525 relates to a technique for displaying a lock window so as to superimpose the lock window on a certain area of an image that needs to be locked. With this technique, when certain input/output processing is performed on an area other than the lock window with a cursor placed on the area, the input/output processing is accepted to perform image processing or to input/output an instruction. Meanwhile, when an operation is carried out with the cursor placed on the lock window, the operation instruction is not regarded as being issued for processing on the image under the lock window, so that data input/output to and from the certain area is forbidden.

Japanese Patent Application Publication No. Hei 7-281860 relates to a technique for providing access security to controls of a GUI, and provides a method and a system for providing security for individual controls in a window of the GUI. According to this technique, upon creation or opening a window including a predetermined control, an area where the control information is obscured from view is defined within the window. Then, access authority is obtained by inputting an authorized password.

Japanese Patent Application Publication No. Hei 11-195033 discloses that a display apparatus for two-dimensional picture information ensures security of each layer of image information and allows the layers in different files to be handled in a unified manner.

Japanese Patent Application Publication No. 2000-181597 relates to a method and an apparatus for protecting, from input, a control in a GUI in a computer system. According to the disclosure, the GUI displays one or more control areas in response to user input. Then, a control is protected from input, by using a translucent overlay, which notifies a user of the protected state. An authorized user activates the grip surface of a cover near the control by use of a pointing device, and then moves the device to remove the cover so that the controls therebelow being a button or a command input field are revealed. Thus, careless operation of the control area can be avoided.

Japanese Patent Application Publication No. 2007-65846, of the present applicants, discloses an information processing apparatus that concurrently executes a plurality of application programs including first and second application programs on an operating system. The information processing apparatus includes: a monitoring component that monitors a function call from the first application program to the operating system or messages being sent and received between the first application program and the operating system; and a control component that modifies or inhibits a function call from the second application program to the operating system or a process for sending and receiving messages between the second application program and the operating system, on the basis of a monitoring result by the monitoring component. This information processing apparatus is cited here for reference as a background art of the present invention.

### SUMMARY OF THE INVENTION

In a general commercial OS such as Windows® which is often used on a client terminal, a graphical user interface (GUI) using a multiwindow system is provided. With this system, a user can process multiple tasks at the same time by switching the windows. However, a usability problem occurs when the multilevel security concept is applied to such a multitask window system. To be precise, in the case of concurrently executing multiple tasks having different security levels on a single desktop screen, it is difficult for the user to intuitively know the level of the current task, that is, to know what is allowed and what is not.

For example, assume that editing of both a non-restricted normal document and a confidential document of which printing or copying is forbidden are carried out concurrently. Since the documents look very similar on the screen even after the windows thereof are switched, the user cannot determine whether an operation is allowed or forbidden until actually carrying out the operation. This causes inconvenience including accidentally carrying out a forbidden operation and thereby unintentionally triggering an alert to the administrator.

In order to improve the GUI, a GUI providing a separate desktop screen for each of security levels is provided. This GUI allows a user to intuitively know the security level of a current task. One example is a method of providing a separate desktop screen for each security level by use of a virtualization technique. In this method, since a program is executed in a dedicated virtual environment that is assigned a specific policy, the user can intuitively know the security level of the current task, and know what operation he/she is forbidden to carry out. However, since data cannot be freely exchanged among the virtual environments, convenient operations such as copy-and-paste and drag-and-drop are excessively restricted even though such convenient operations are basically harmless enough to be allowed. Hence, there is a drawback of diminished usability of the system. Moreover, the method also requires setup of the virtual environment for each of the security levels, as well as software licenses therefor.

In some secure OSs such as Trusted Solaris™, a window system supporting a security label is provided. However, this system does not control the display state of a GUI, but merely controls access to property information on each window, or permit/not permit a clipboard operation. For this reason, intuitive recognition of a security level of a current task cannot be achieved by using this system.

Although the object of enhancing security is achieved in the above-mentioned conventional arts, it is still difficult to implement a GUI of a high usability and, at the same time achieve flexibility in controlling the information flow. Moreover, in the conventional arts as described above, it is not clear which of the windows is given a high security level, and which a low security level.

It is an object of the present invention to improve the usability of GUI for users, in a system including multiple security levels.

It is another object of the present invention to provide a multiwindow system which allows a user to recognize the security level of a window more easily, in a system including multiple security levels.

In one aspect of the present invention, security levels and positional information in the Z-axis direction (Z-order) of windows on the screen are associated, and a limitation is provided so that a program that is assigned a low security level does not become higher than a program that is assigned a high security level in the Z-axis direction. In addition, information flow by use of a clipboard and a window message is limited from a higher program to a lower program in the Z-axis direction. The security levels are managed on the window basis according to attributes of files to be accessed or documents to be displayed. In this way, the display state of each window in the desktop is dynamically controlled depending on the security level of the window on which a user actually performs operation. Moreover, the visual state of system resource such as a printer and a drive is also controlled in accordance with the assigned security level.

In the present invention, residing in each of the processes are: a state monitoring unit for monitoring an active state, a position in the Z-axis direction, and the like of a window; a security level determination unit for reevaluating the security level in response to a change in a state; a state controller for controlling the visual state of a window; and an access controller for controlling access to resources such as the clipboard and the window message. The state monitoring unit monitors positional change events of a window owned by the process in which the unit resides, in the Z-axis direction. The state monitoring unit detects a movement of the window to a higher layer than windows that are assigned a higher security level than itself. Then, the system sends a state modification request to each of the state controllers in the processes that own the involved windows that are assigned the higher security level. Upon receipt of the request, each of the state controllers in the processes of a high security level makes the state of the corresponding window to be invisible and thereby to disappear from the screen. In addition, when the state is changed, the access controller eliminates data left on the clipboard, as well as restricts data output from a higher level program to the clipboard, and message transmission from the higher level program to a lower level program. Note that, in order to determine the owner of data on the clipboard, the access controller always writes, as additional information, the security level of a write source program in a user definition area, when a program outputs data to the clipboard. Moreover, the state monitoring unit and the security level determination unit perform cooperative operation to reevaluate the security level of a program in response to a state change in the GUI.

Meanwhile, a security level restoration GUI display unit resides in the system, and provides the user with a GUI to issue a return request to a high level program. The GUI may either be clicking of a window icon in a task bar, or a level selecting slide bar resident in a task tray. Alternatively, the GUI may be a scheme of causing an invisible window in a higher layer to become translucent when a specific hot key (such as Shift key) is held down. When a user makes a return request to a high level program by use of such a GUI, a state modification request is sent to the state controller in the high level program. Upon receipt of the request, the state controller causes the invisible window to become visible in the original position in the Z-axis direction. As a result, the window of a low security level which has been focused is defocused, and is moved to a lower layer in the Z-axis direction.

Note that in another aspect of the present invention, the relationship between the security levels and the Z-order of the windows is reversed, and the programs are controlled so that a program of a high security level does not become higher in the Z-axis direction than a program of a low security level.

### BRIEF DESCRIPTION OF THE DRAWINGS

For a more complete understanding of the present invention and the advantage thereof, reference is now made to the following description taken in conjunction with the accompanying drawings.

FIG. 1 is a block diagram of hardware of a computer for implementing the present invention.

FIG. 2 is a functional block diagram of the mechanism of window monitoring according to an embodiment of the present invention.

FIG. 3 is a flowchart of window monitoring processing according to the embodiment of the present invention.

FIG. 4 is a flowchart of window restoration for display processing according to the embodiment of the present invention.

FIG. 5 is a diagram illustrating a window displayed by use of a security level restoration GUI.

FIGS. 6A and 6B illustrate the correspondence between a displayed state of windows and the security levels thereof.

FIGS. 7A and 7B illustrate the correspondence between a displayed state of windows and the security levels thereof.

FIGS. 8A and 8B illustrate the correspondence between a displayed state of windows and the security levels thereof.

FIGS. 9A and 9B illustrate the correspondence between a displayed state of windows and the security levels thereof.

### DETAILED DESCRIPTION OF THE PREFERRED EMBODIMENTS

Hereinafter, in reference to the drawings, a description will be given for a configuration and processing of an embodiment of the present invention. In the following description, the same elements among the drawings are denoted by the same reference numerals, if not specified otherwise. Note that the configuration and processing in the description are given only as examples of an embodiment, and are not intended to limit the understanding of the technical scope of the present invention.

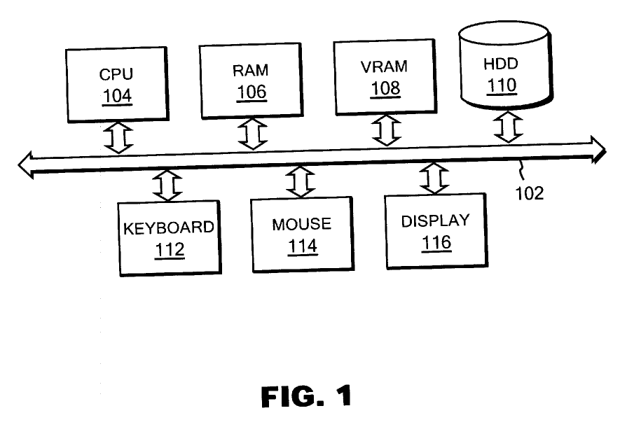

FIG. 1 shows a block diagram of computer hardware for implementing a system configuration and processing according to the embodiment of the present invention. In FIG. 1, a CPU 104, a main memory (RAM) 106, a video memory (VRAM) 108, a hard disk drive (HDD) 110, a keyboard 112, a mouse 114, and a display 116 are connected to a system bus 102. The CPU 104 is preferably based on a 32-bit or 64-bit architecture, Pentium® 4 of Intel Corporation, Athlon™ of AMD, or the like, may be used as the CPU 104. The main memory 106 preferably has a capacity of 512 KB or more. The video memory 108 is used to retain images to be outputted as screens on the display 116.

Although not individually shown in the drawing, an operating system, a processing program according to the present invention and application programs thereof are previously stored in the hard disk drive 110. The application programs include a word processor, a spreadsheet program, a presentation program, a database program and the like. The operating system may be any operating system that supports the multiwindow graphic user interface and that is compatible with the CPU 104, such as: Linux®, Microsoft Windows XP™ or Microsoft Windows 2000™, and Mac OS® of Apple Inc. Note that for convenience, Windows XP™ is used as the operating system and Win32 API is used as the API in the description below. However, a person skilled in the art should understand that APIs equivalent to Win32 are also included in other operating systems such as Linux®, and that the present invention can be implemented with such other operating systems.

Although not a requirement, the display 116 preferably has a resolution of equal to or more than 1024×768 pixels and is a 32-bit true color LCD monitor.

The keyboard 112 and the mouse 114 are used to operate, according to the GUI that the operating system provides, graphic objects displayed on the display 116, such as an icon, a task bar and a window.

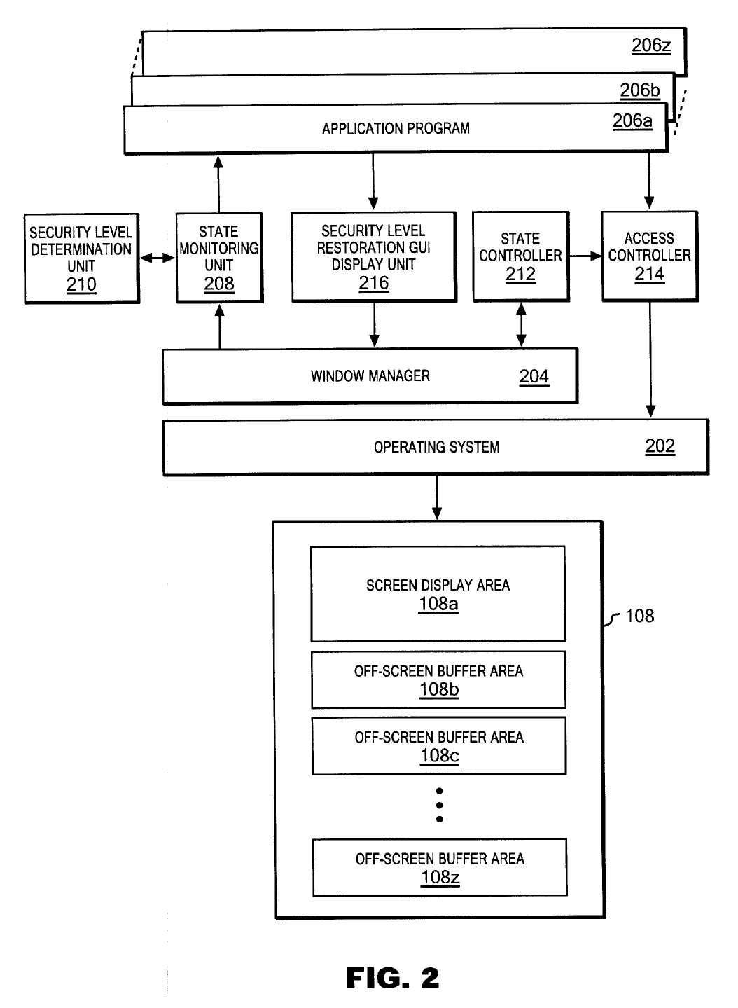

FIG. 2 shows a functional block diagram of the present invention. An operating system 202 in FIG. 2 is stored in the hard disk 110, and is loaded into the RAM 106 to operate when the computer shown in FIG. 1 is powered on. Main functionalities of the operating system 202 are: a functionality of controlling input/output to and from peripheral devices such as the hard disk 110, the keyboard 112, the mouse 114, and the display 116; a program load functionality; and a task switch functionality.

A window manager 204 is a system that provides a GUI environment for controlling operations such as displaying a window on the display 116, resizing a window, hiding a window, making a window disappear, bringing, to the top, a window designated by a user with a click on the mouse, and copying data from one window to another by use of a clipboard. In Linux®, X Window System corresponds to the window manager 204. In Windows XP™, the window manager 204 is included in the operating system 202 as a part of a functionality thereof. Specifically, Win32k.sys, GDI32.DLL and the like constitute the functionality. However, since these are known functions, detailed descriptions thereof are omitted here.

Application programs 206a, 206b, . . . , 206z are a word processor, a spreadsheet program, a presentation program and the like, for example, and are stored in the hard disk drive 110. With an operation by a user on the mouse 114 or the keyboard 112, a functionality of the operating system 202 loads the application programs onto the main memory 106. Then, a functionality of the window manager 204 executes the application programs concurrently while displaying them in different windows.

Next, a description will be given for distinctive functionalities of the present invention which are: a state monitoring unit 208, a security level determination unit 210, a state controller 212, an access controller 214, and a security level restoration GUI display unit 216. These functionalities are written in any appropriate programming language processing system that is designed for writing a functionality that can monitor processes and threads by calling an API function provided by the operating system 202. Such programming language processing systems include C, C++, C#, and Java™. The functionalities are stored in the hard disk drive 110, incorporated into the startup routine, and are controlled by the operating system 202 so as to be automatically loaded onto the main memory 108 and to be executed when the computer system shown in FIG. 1 is powered on.

In FIG. 2, the state monitoring unit 208, the security level determination unit 210, the state controller 212, and the access controller 214 are illustrated as functionalities independent from the application programs 206a, 206b, . . . , 206z. However, note that the state monitoring unit 208, the security level determination unit 210, the state controller 212, and the access controller 214 are preferably included and resident in each of the processes inside the application programs 206a, 206b, . . . , 206z, and have a functionality of monitoring from one application program to another application program.

The state monitoring unit 208 uses a message hook mechanism provided by the window manager 204. The state monitoring unit 208 monitors messages send by the window manager 204, and thereby detects a change in the Z-order or in the active state of the windows. For instance, the state monitoring unit 208 monitors the WM_WINDOWPOSCHANGING message to detect a position change of a window in the Z-axis direction, that is, a relocation of the window to an upper or lower layer in the stack of windows. Meanwhile, the state monitoring unit 208 monitors the WM_ACTIVATE message to detect a focus or unfocus of a window. Upon detection of a state change of a window, the state monitoring unit 208 sends a request to the state controllers 212 in the processes to change the visual state of the window, according to need. In addition, the state monitoring unit 208 makes a request of the later-described security level determination unit 210 to reevaluate the security level.

In response to the event reported by the state monitoring unit 208, the security level determination unit 210 reevaluates the security level of a window owned by the process in which the unit resides. For example, in a case such as where a new document is opened in an application, the security level determination unit 210 reevaluates the security level of the window according to an attribute of the opened document. Incidentally, in the case of a simple program such as Calculator in Windows, the security level determination unit may be omitted since the same security level can always be applied to the single process.

According to the present invention, a security level ranging from 1 to 3, for example, is assigned to each of the application programs 206a, 206b, . . . , 206z. Suppose that a larger number indicates a higher security level. Japanese Patent Application Publication No. 2007-65846 discloses an exemplar technique for assigning security levels to application programs or to processes generated by application programs. The disclosed technique monitors messages exchanged between application programs being executed on an operating system 202, and modifies or inhibits processes on the basis of a separately prepared policy.

An example of a policy for setting a security label for each file is shown below, where <Rule Ruleld=“urn:rule1”> describes a security level to be set. Specifically, in addition to “urn:rule1,” multiple security labels such as “urn:rule0” and “urn:rule2” are prepared. Additionally, the application program to which the security label is applied is described in <AttributeValue DataType=“file:path”>˜</AttributeValue>.

<!-- Group 1 -->

<Rule RuleId=“urn:rule1”

<Description>Deny clipboard copy and print by notepad and

calc</Description>

<Subjects>

<Subject>

<AttributeValue
DataType=“file:path”>calc.exe</AttributeValue>

</Subject>
<Subject>

<AttributeValue
DataType=“file:path”>notepad.exe</AttributeValue>

</Subject>

</Subjects>

<Resources>

<Resource DataType=“clipboard” Lib=“SBLCLIP”>

<!-- inhibit copying to clipboard -->
<AttributeValue DataType=“clipboard:type”>

<AnyClipboardDataType/>

</AttributeValue>
<Actions>

<Action Effect=“Deny”>write</Action>

</Actions>

</Resource>

...........
...........
</Rule>

Similarly, a security level can be set for each of the processes generated in an application program, and a security level may be set to a child window generated from a certain window, for example. Such a functionality for setting security levels, however, is not the gist of the invention and therefore further description thereof is omitted herein. Refer to Japanese Patent Application Publication No. 2007-65846 or other conventional arts, according to need. In response to a request from the state monitoring unit 208, the security level determination unit 210 detects the security level of the application program by use of the above-mentioned functionality, and returns the detection result to the state monitoring unit 208.

The state controller 212 controls the visual state of a window by calling the window visual state modification API in the process in which the state controller 212 resides. For example, the state controller 212 calls APIs such as SetWindowPlacement, SetLayeredWindowAttributes, and SetWindowPos to change the visual state or the Z-order of a window, or to make a window translucent. At this time, the visual states of windows are basically controlled in group units, rather than being controlled separately, according to the parent-child relationships or owner-owned relationships between windows. For instance, even in a case where a modal dialogue is displayed in an application, the modal dialogue window and its owner window, that is the main window of the application, are regarded as a set. The state controller 212 also modifies other window attributes according to need. For example, in a case where a window of a low security level is displayed as having the topmost attribute (WS_EX_TOPMOST), the state controller 212 adjusts the Z-order to display a window of a higher security level. Specifically, the Z-order is adjusted so that the topmost attribute is temporarily removed from the window of a low security level to be displayed in a lower layer than the window of a high security level.

In a case where a window of a program of a high security level is hidden, the security level restoration GUI display unit 216 provides a user with a GUI to request the restoration of the window of the program of a high security level. In response to user instruction, the GUI sends a state modification request to each of the state controllers 212 in the processes. On receiving the request, the state controller 212 restores to display the corresponding window that has been hidden, in its original position in the Z-axis direction. Such GUI may be implemented in various forms. The GUI may be implemented as a dedicated individual program such as a resident icon in a task bar or in a task tray. Alternatively, a seamless GUI may be implemented inside the window manager 204 in cooperation with the state monitoring unit 208 and the state controller 212. Specifically, in the seamless GUI, the state monitoring unit 208 detects either the holding-down of a specific hot key (such as Shift key), or the pressing-down of a combination of specific keys (such as Alt key+cursor up key). Then, a request is sent to each of the state controllers 212 in the high security level processes in the non-visible states, to cause the windows owned by the processes to be restored for display.

The state of a GUI may be restored, in response to a new start-up of a program of a high security level in addition to the security level restoration request sent by the security level restoration GUI display unit 216. In this case, by use of the GUI and similar operations, the window of a low security level which has been focused is defocused, and is moved to a lower layer in the Z-axis direction.

The operating system 202 further writes, copies, or moves a bitmap value in the VRAM 108 according to a drawing instruction from the window manager 204, to thereby actually draw windows and other graphics on the display 116. Specifically, the VRAM 108 includes a screen display area 108a, and multiple off-screen buffer areas 108b, 108c, . . . , 108z. The off-screen buffer areas 108b, 108c, . . . , 108z respectively correspond to the windows, including child windows, of the application programs 206a, 206b, . . . , 206z. When an application program is activated and a window thereof appears, the off-screen buffer area corresponding to the application program is allocated in the VRAM 108 by using an API function such as CreateBitmap. Then, the window is actually displayed on the display 116 by carrying out bitblock transfer of the bitmap value stored in this off-screen buffer area onto the screen display area 108a. The bitblock transfer is carried out by using an API function such as BitBlt. On the other hand, the window disappears from the screen when the content of the screen display area 108a is saved into a corresponding off-screen buffer area.

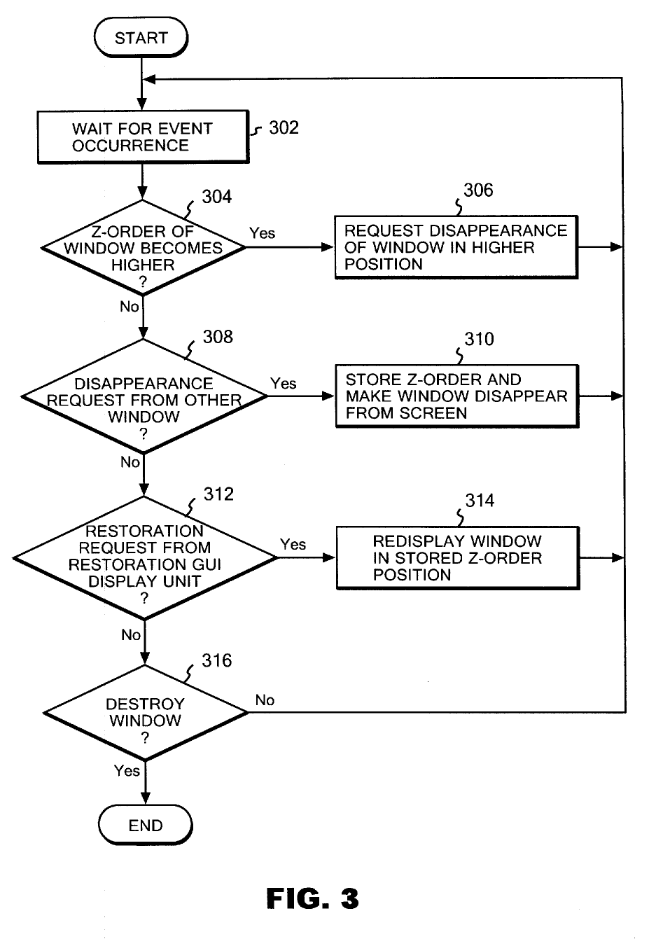

FIG. 3 is a flowchart of the process in accordance with the present invention. In step 302 in FIG. 3, the state monitoring unit 208 waits for an occurrence of an event. Here, an event refers to processing such as a change in the Z-order of windows, disappearance of a window, redisplay of a window that has disappeared, and destruction of a window.

When the state monitoring unit 208 detects such an event, in step 304, a determination is made on whether the Z-order of a window has become higher. “The Z-order of a window has become higher” means, for example, that a window in a lower Z-order is clicked with a mouse to be brought to the topmost Z-order. When it is detected that the Z-order of the window has become higher, in step 306, a window having had a higher Z-order and having a higher security level than the window moved to the topmost Z-order is made to disappear. This operation requires acquisition of security levels of the respective windows, which can be obtained through queries from the state monitoring units 208 to the security level determination units 210.

If the Z-order of the window has not become higher, in step 308, a determination is made on whether the event is a disappearance request from a different window. A disappearance request from a different window is, for example, a request to make this window disappear because the different window with a lower security level than this window is moving to a higher layer on the Z axis. In addition, the disappearance request includes an instruction given to make a child window disappear, along with the disappearance of its parent window. In such cases, in step 310, the Z-order of the window is stored and thereafter the window is made to disappear. Here, when the window disappears, the window may merely be minimized, may be moved to a task tray displayed in a dedicated appropriate GUI by the security level restoration GUI display unit 216, or may be made translucent. Note that the value of the Z-order to be saved is stored readably in a certain area, held by the state monitoring unit 208, in the main memory 106, for example.

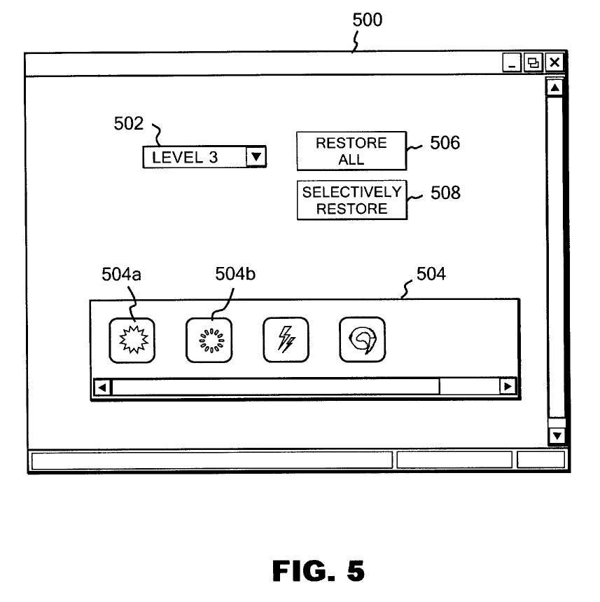

If the event is not a disappearance request from a different window, in step 312, a determination is made on whether the event is a redisplay request from the security level restoration GUI display unit 216. If the event is a redisplay request, in step 314, the window requested to be redisplayed is displayed in the Z-order position stored in association with the window. The window may be restored, for example, with a specified operation on a task tray area 504 in a GUI as shown in FIG. 5, which is displayed by the security level restoration GUI display unit 216. Alternatively, the window may be restored by using, as a trigger, the operation of simultaneously pressing the Ctrl key and R key with a mouse cursor placed on the corresponding window icon in the task tray.

Note that the description “redisplay request from the restoration GUI display unit” is only an example. That is, in a case where the window is minimized, the description means an instruction to restore the window to the original size. Alternatively, in a case where the window is made translucent, the description means an instruction to restore the window to the original non-translucent state.

If the event is not a redisplay request, in step 316, a determination is made on whether the window is destroyed. A destruction of a window means, for example, to destroy a monitored window with an operation such as clicking on an “X” in the right upper corner of the window. That is, if the monitored window is destroyed, the event thereof no longer needs to be monitored, and thus the processing is terminated.

If the event is not a destruction of a monitored window, the processing returns to step 302, and waits for occurrence of the next event. Additionally, although not illustrated in FIG. 3, for security management, copying of documents, data, graphic data, bitmap, and the like, from a window of a high security level to a window of a low security level is inhibited. Such an inhibition mechanism is provided in Japanese Patent Application Publication No. 2007-65846, for example. Note that the processing shown in the flowchart of FIG. 3 is carried out for each of the windows. That is, multiple sets of the processing are performed in parallel as multitask processing.

Moreover, although also not shown in FIG. 3, according to the processing of the embodiment, the Z-order of a window of a newly started application is selected to be higher than that of a window of a security level lower than the application, and to be lower than that of a window of a security level higher than the application.

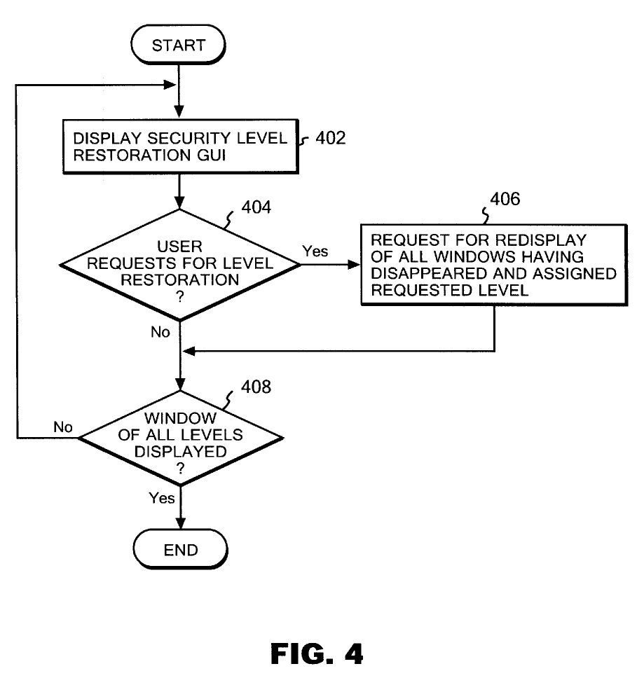

FIG. 4 is a flowchart of processing of the security level restoration GUI display operation. In step 402, a security level restoration GUI is displayed. This is displayed in response to pressing-down of the combination of Alt key+cursor up key, for example.

FIG. 5 shows an example of a security level restoration GUI 500. In FIG. 5, a combo box 502 is provided for setting the security level of a window to be restored. In response to the switching of levels by use of the combo box 502, window icons 504a, 504b, . . . , each hidden and assigned the designated security level are displayed in the area 504.

The GUI shown in FIG. 5 further includes a “restore all” button 506 and a “selectively restore” button 508. In step 404 in FIG. 4, a determination is made on whether a request is made to restore the windows assigned the security level that is designated using the combo box 502. In other words, a determination is made on whether the user has clicked the “restore all” button 506.

Then, if the user clicks the “restore all” button 506, the processing proceeds to step 406, and a request is made to restore all the windows having disappeared and being assigned the requested security level (all of the iconized windows in the area 504 in FIG. 5). Here, as has been described in reference to step 310 in FIG. 3, the expression “restore (restoration)” means displaying a window in the stored original Z-order.

Although not explicitly shown in the flowchart in FIG. 4, it is possible to restore only the selected windows in the following manner. Specifically, in the GUI shown in FIG. 5, one or more icons of hidden windows are selected by using an interface such as clicking, with the mouse cursor, the window icons 504a, 504b, . . . , displayed in the area 504 while pressing down the Ctrl key, and then by clicking the “selectively restore” button 508.

The description returns to FIG. 4. Thus, if it is determined in step 408 that windows of all security levels are restored for display, the restoration processing is completed. On detecting that there are no more windows to be restored for display, the system may automatically shut down the GUI in FIG. 5, or the user may manually shut down the GUI in FIG. 5.

If there are more windows to be restored for display, and the user desires to continue the processing, the processing in FIG. 4 returns to step 402.

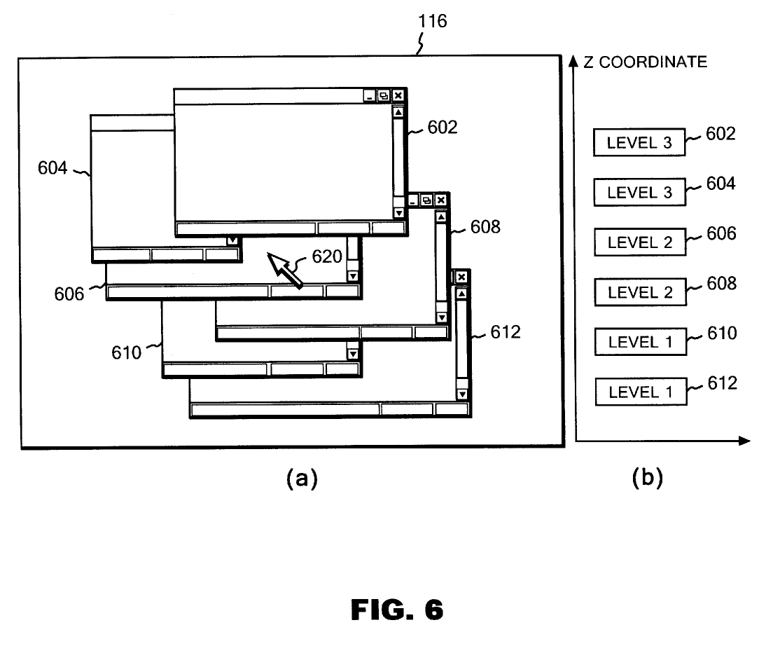

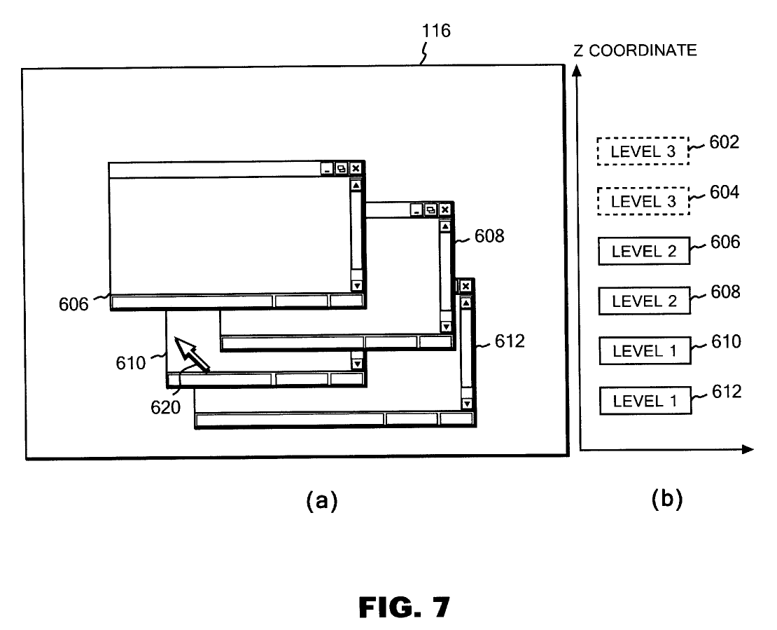

Next, with reference to FIGS. 6A to 9B, a concrete description will be given of processing for hiding or restoring windows. FIG. 6A shows a state in which multiple windows 602, 604, 606, 608, 610, and 612 are displayed on the display 116. FIG. 6B shows the Z-order (Z coordinate) and the security levels of the windows 602, 604, 606, 608, 610, and 612 shown in FIG. 6A. Note that the reference numbers of the windows in FIG. 6A correspond to those in FIG. 6B. The same goes with those in FIGS. 7A to 9B.

As can be seen from FIG. 6B, the windows 602 and 604 are assigned the security level 3, the windows 606 and 608 are assigned the security level 2, and the windows 610 and 612 are assigned the security level 1.

Suppose that a user clicks the window 606 with a mouse cursor 620. This operation indicates that the window 606 is caused to have the topmost Z-order. However, according to the embodiment of the present invention, the state monitoring unit 208 detects this change in state, and gives a positive decision in step 304 in FIG. 3 for the window 606. With this operation, in step 306 for the window 606, a request is made to make the windows 602 and 604 disappear since the windows 602 and 604 has a high security level and has had higher Z-orders than the window 606. This request leads to Yes in step 308 and causes the execution of step 310 for each of the windows 602 and 604. As a result, the windows 602 and 604 are made to disappear. The processing is carried out in response to a request from the state controller 212 to the window manager 204.

Consequently, as shown in FIG. 7A, the windows 602 and 604 are made to disappear, so that the window 606 becomes the topmost window. In FIG. 7B, the windows 602 and 604 having disappeared in this manner are illustrated in broken lines.

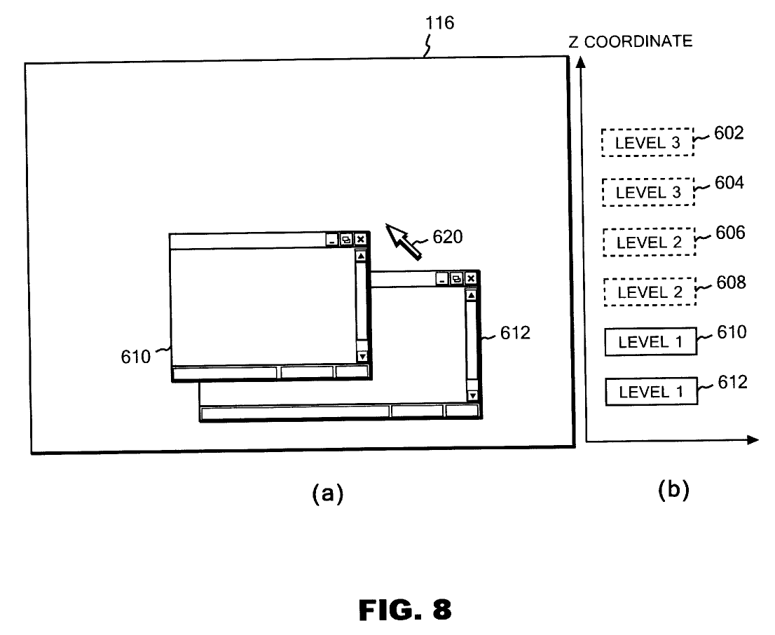

Further, suppose that the user clicks the window 610 with the mouse cursor 620 in FIG. 7A. This operation indicates that the window 610 is caused to have the topmost Z-order. Hence, a request is made to make the windows 606 and 608 disappear with the same processing as described in reference to FIGS. 6A and 6B. The resultant state is shown in FIGS. 8A and 8B.

When Alt key and cursor up key are simultaneously pressed down in this state, this key entry is detected by the state monitoring unit 208, and the GUI 500 in FIG. 5 appears on the screen 116. If level 2 is selected in the combo box 502, minimized icons of the windows 606 and 608 which are assigned the level 2 and currently hidden are displayed in the area 504. At this time, if the “restore all” button 506 is clicked, the windows 606 and 608 are restored in the original Z-order according to step 406 in FIG. 4, more specifically, according to step 314 in FIG. 3. The resultant state is shown in FIGS. 7A and 7B.

Moreover, if level 3 is selected in the combo box 502, minimized icons of the windows 602 and 604 which are assigned the level 3 and currently hidden are displayed in the area 504. At this time, if the “restore all” button 506 is clicked, the windows 602 and 604 are restored in the original Z-order according to step 406 in FIG. 4, more specifically, according to step 314 in FIG. 3. The resultant state is shown in FIGS. 6A and 6B.

Additionally, although the windows are restored in the order of level 2 to level 3 in the above restoration operation, the restoration order may be set freely. Alternatively, the windows may be restored in the order of level 3 to level 2. In this case, the windows 602 and 604 assigned the level 3 are first restored on top of the window 610, and then the windows 606 and 608 assigned the level 2 are restored on top of the window 610. Here, since the Z-orders of the windows are stored along with the disappearance of the windows in step 310 of FIG. 3, the stored Z-orders are used in restoration, and thus the windows can be placed in the correct Z-order position.

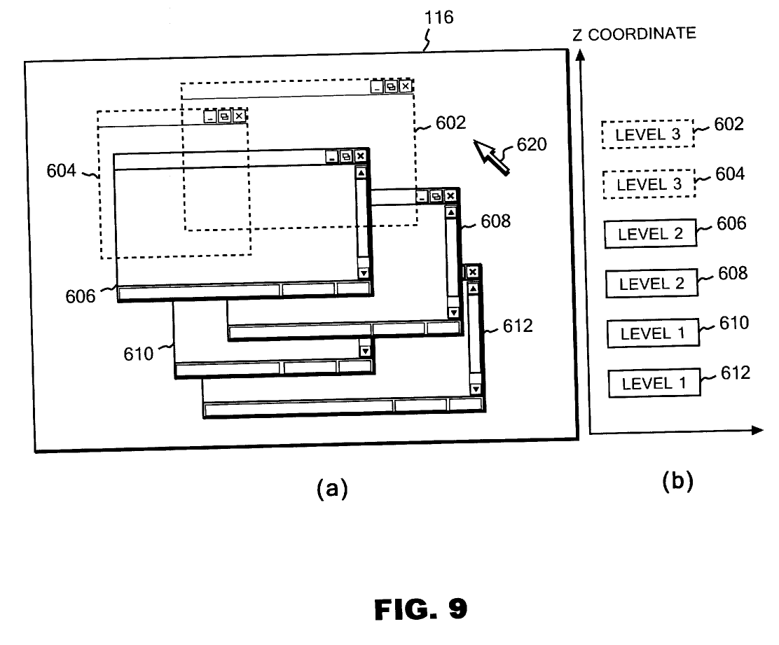

FIGS. 9A and 9B show another embodiment of the present invention. In FIGS. 7A and 7B, selection of the window 606 assigned the security level 2 makes the windows 602 and 604 placed thereon and assigned a higher security level completely disappear from the display screen. However, in FIGS. 9A and 9B, the attributes of the windows 602 and 604 are modified so that the windows 602 and 604 are merely made translucent as illustrated in dotted lines, instead of disappearing. Thus, the windows 602 and 604 are displayed provisionally but are inactive, so that operations can be carried out on the windows of a lower security level, such as the window 606, independently of the translucent windows 602 and 604. In this case, the translucent windows may be restored to the active state by use of a GUI as shown in FIG. 5, or by clicking the translucent window with a mouse button while pressing down a specific hot key combination such as Ctrl+R.

Additionally, although in the aforementioned embodiments the windows are respectively controlled by different applications, the present invention can also be applied to a so-called multiple document interface (MDI) where multiple documents are respectively opened in different windows within a single process. In such a case, different security levels can be assigned to the respective windows of the documents by use of a technique disclosed in U.S. patent application Ser. No. 11/755,769 applied for by the applicants of the present invention on May 31, 2007, for example. In this case, the same effects can be achieved by controlling the positional relationships among child windows inside the MDI application. The state monitoring unit 208 can monitor the positional relationships among the child windows by monitoring MDI-specific messages related to positional relationships of child windows such as WM_MDIACTIVATE and WM_MDIMAXIMIZE, in addition to messages related to positional relationships of parent windows such as WM_ACTIVATE and WM_WINDOWPOSCHANGING. Similarly, the state controller 212 can control the positional relationships among the child windows by transmitting MDI control messages.

Although windows of a high security level are placed in relatively high Z-orders in the embodiments, the windows may be placed in the inverse order according to need. That is, windows of a low security level may alternatively be placed in relatively high Z-orders. In this case, a window of a low security level is made to disappear or to be translucent when the Z-order of a window that is assigned a high security level becomes higher than the Z-order of a window that is assigned a low security level. Processes other than that, including the restoration for display, is basically the same as those in the above embodiments.

Additionally, in the embodiments, a security management functionality of a desired screen is achieved by controlling the label map through monitoring of drawing instructions, by use of a monitoring program executed on an operating system. However, if a user is authorized or in a position to write and edit the source code of an operating system, the functionalities of the present invention may be implemented as native functionalities of the operating system.

By employing this invention, a user is less likely to be troubled with the security level of the window currently in use, and thus the usability of the system is improved. This is because the security levels and positional information of the windows in the Z-axis direction on the screen are associated with each other, and because the system is automatically controlled to hide a window of a high security level program in response to an operation for causing a window of a low security level program to have a high Z value.

While the present invention has been described with reference to what are presently considered to be the preferred embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadest interpretation so as to encompass all such modifications and equivalent structures and functions.

What is claimed is:

1. A computer implemented multiwindow system comprising:
a plurality of windows displayed in a Z-order wherein each window is assigned a security level;
a monitoring unit for monitoring a change in the Z-order of the displayed windows, wherein the change is that the Z-order of a window becomes higher in the Z-order than the Z-order of another window that has a higher security level; and
a window manager for causing the window that is assigned the higher security level to disappear or to become translucent in response to the change in the Z-order.

2. The multiwindow system according to claim 1, further comprising means for restoring the window that disappeared or became translucent.

3. The multiwindow system according to claim 2, wherein the means for restoring the window restores all windows assigned the same security level that disappeared or became translucent.

4. A computer implemented control method for a multiwindow system comprising the steps of:
displaying a plurality of windows in a Z-order wherein each window is assigned a security level;
monitoring a change in the Z-order of the displayed windows, wherein the change is that the Z-order of a window becomes higher in the Z-order than the Z-order of another window that has a higher security level; and
causing the window that is assigned the higher security level to disappear or to become translucent in response to the change in the Z-order.

5. The control method for a multiwindow system according to claim 4, further comprising the step of restoring the window that disappeared or became translucent.

6. The control method for a multiwindow system according to claim 5, wherein the step for restoring the window includes restoring all windows with the same security level that disappeared or became translucent.

7. A computer readable article of manufacture tangibly embodying computer readable instructions for executing a computer implemented control method for a multiwindow system, the method comprising the steps of:
displaying a plurality of windows in a Z-order wherein each window is assigned a security level;
monitoring a change in the Z-order of the displayed windows, wherein the change is that the Z-order of a window becomes higher in the Z-order than the Z-order of another window that has a higher security level; and
causing the window that is assigned the higher security level to disappear or to become translucent in response to the change in the Z-order.

8. The control program for a multiwindow system according to claim 7, further comprising the step of restoring the window that disappeared or became translucent.

9. The control program for a multiwindow system according to claim 8, wherein the step for restoring the window restores all windows with the same security level that disappeared or became translucent.

10. A computer implemented multiwindow system comprising:
a plurality of windows displayed in a Z-order wherein each window is assigned a security level;
a monitoring unit for monitoring a change in the Z-order of the displayed windows, wherein the change is that the Z-order of a window becomes higher in the Z-order than the Z-order of another window that has a lower security level; and
a window manager for causing the window that is assigned the lower security level to disappear or to become translucent in response to the change in the Z-order.

11. The multiwindow system according to claim 10, further comprising means for restoring the window that disappeared or became translucent.

12. The multiwindow system according to claim 11, wherein the means for restoring the window restores all windows assigned the same security level that disappeared or became translucent.

13. A computer readable article of manufacture tangibly embodying computer readable instructions for executing a computer implemented control method for a multiwindow system, the method comprising the steps of:
displaying a plurality of windows in a Z-order wherein each window is assigned a security level;
monitoring a change in the Z-order of the displayed windows, wherein the change is that the Z-order of a window becomes higher in the Z-order than the Z-order of another window that has a lower security level; and
causing the window that is assigned the lower security level to disappear or to be translucent in response to the change in the Z-order.

14. The control program for a multiwindow system according to claim 13, further comprising the step of restoring the window that disappeared or became translucent.

15. The control program for a multiwindow system according to claim 14, wherein the step for restoring the window restores all windows assigned the same security level that disappeared or became translucent.
